(19) United States
(12) Patent Application Publication
(10) Pub. No.: US 2007/0047431 A1
(43) Pub. Date: Mar. 1, 2007

(54) Radio transmission apparatus and peak power suppression method in multicarrier communication

(75) Inventors: Akihiko Nishio, Kanagawa (JP); Kenichi Miyoshi, Kanagawa (JP); Isamu Yoshii, Kanagawa (JP); Atsushi Matsumoto, Ishikawa (JP)

Correspondence Address: STEVENS, DAVIS, MILLER & MOSHER, LLP, 1615 L. STREET N.W., SUITE 850, WASHINGTON, DC, 20036, US

(73) Assignee: Matsushita Electric Industrial Co., Ltd., Osaka (JP)

(21) Appl. No.: 10/580,963

(22) PCT Filed: Nov. 19, 2004
(86) PCT No.: PCT/JP04/17285

§ 371 Date: Jul. 19, 2006

(30) Foreign Application Priority Data
Dec. 2, 2003 (JP) 2003-403415

(51) Int. Cl. H04J 11/00

(52) U.S. Cl. 370/203

(57) ABSTRACT

A radio transmission apparatus capable of suppressing peak power without causing deterioration in throughput and degradation in transmission efficiency in multicarrier communication. In this apparatus, a coding section (11) codes transmission data, a modulation section (12) modulates the coded data to generate a symbol, an assigning section (13) assigns the symbol to one of a plurality of subcarriers constituting a multicarrier signal, a changing section (15) change the phase of each of the plurality of subcarriers within a range that does not cross a decision boundary for signal points on an IQ plane, and an IFFT section (16) generates a multicarrier signal by inverse fast Fourier transform.

### TECHNICAL FIELD

The present invention relates to a radio transmission apparatus and peak power suppression method in multicarrier communication.

### BACKGROUND ART

In mobile communications, the demand for communicating various media such as speech, moving picture, data and so forth at high speed has increased. In high-speed packet communication, the use of multicarrier communication has been examined that can reduce the impact of multipath propagation which is unique to mobile communications, such as OFDM (Orthogonal Frequency Division Multiplexing), MC-CDMA (Multi Carrier-Code Division Multiple Access) and the like.

However, in multicarrier communication using a large number of subcarriers, peak power becomes an extremely high value relative to the average power when the phases of subcarriers synchronize. When peak power is high, signals are distorted due to limitations of a linear amplifier, and communication characteristics (for example, BER: Bit Error Rate) deteriorate. Accordingly, various studies have been made not to produce high peak power.

One of such studies is to control not to transmit subcarriers of low reception quality. Peak power is suppressed by making subcarriers not to be transmitted (for example, see Non-patent Document 1).

Another one of the studies is to add a different phase rotation to each subcarrier and transmit. Peak power is suppressed by making the phases of subcarriers out of synch (for example, see Patent Document 1).

Patent Document 1: Japanese Patent Application Laid-Open No. 2002-359606

Non-patent Document 1: Maeda, Sampei, Morinaga, “Performance of the Delay Profile Information Channel based Subcarrier Transmit Power Control Technique for OFDM/FDD Systems”, IEICE Transactions, B, Vol. J84-B, No. 2, pp. 205-213 (February, 2001)

### DISCLOSURE OF INVENTION

### Problems to be Solved by the Invention

However, in the technique described in Non-patent Document 1, subcarriers not to be transmitted are produced, so that the number of bits that can be transmitted decrease, and the throughput may deteriorate. Further, it is necessary to separately report the information regarding positions of the subcarriers not to be transmitted to the receiver side, and consequently transmission efficiency degrades.

In the technique described in Patent Document 1, it is necessary to separately report the information regarding phase rotation indicative of a degree of given phase rotation to the receiver side, and consequently the transmission efficiency degrades.

It is therefore an object of the present invention to provide a radio transmission apparatus and peak power suppression method whereby peak power can be suppressed without causing deterioration in throughput and degradation in transmission efficiency.

### Means for Solving the Problem

In the present invention, peak power of a multicarrier signal is suppressed by changing the phase of each of a plurality of subcarriers within a range that does not cross a decision boundary between a signal point on an IQ plane in which a symbol assigned to each of the plurality of subcarriers is placed and an adjacent signal point.

### Advantageous Effect of the Invention

According to the present invention, it is possible to decrease peak power while preventing deterioration in throughput and degradation in transmission efficiency in multicarrier communication.

### BRIEF DESCRIPTION OF DRAWINGS

FIG. 1 is a block diagram illustrating a configuration of a radio transmission apparatus according Embodiments 1 and 2 of the present invention;

FIG. 2 is a graph illustrating a peak power determination method according to Embodiment 1 of the invention;

FIG. 3 is an explanatory view of a decision boundary according to Embodiment 1 of the invention (BPSK);

FIG. 4 is an explanatory view of decision boundaries according to Embodiment 1 of the invention (QPSK);

FIG. 5 is an explanatory view of decision boundaries according to Embodiment 1 of the invention (8PSK);

FIG. 6 is an explanatory view of decision boundaries according to Embodiment 1 of the invention (16QAM);

FIG. 7 is a view showing a change range according to Embodiment 1 of the invention (Example 1);

FIG. 8 is a view showing a change range according to Embodiment 1 of the invention (Example 2);

FIG. 9 is a view showing a change range according to Embodiment 1 of the invention (Example 3);

FIG. 10 is a view showing a change range according to Embodiment 1 of the invention (Example 4);

FIG. 11 is a view showing a change range according to Embodiment 1 of the invention (Example 5);

FIG. 12 is a view showing a change range according to Embodiment 1 of the invention (Example 6);

FIG. 13 is a graph showing simulation results according to Embodiment 1 of the invention;

FIG. 14 is a view showing a change range according to Embodiment 1 of the invention (Example 7);

FIG. 15 is a view showing a change range according to Embodiment 1 of the invention (Example 8);

FIG. 16 is a view showing a change range according to Embodiment 1 of the invention (Example 9);

FIG. 17 is a view showing a change range according to Embodiment 1 of the invention (Example 10);

FIG. 18 is a view showing a change range according to Embodiment 1 of the invention (Example 11);

FIG. 19 is a processing flow diagram according to Embodiment 1 of the invention;

FIG. 20 is a processing timing diagram according to Embodiment 1 of the invention;

FIG. 21 is a block diagram illustrating a configuration of a radio transmission apparatus according Embodiment 3 of the invention;

FIG. 22 is a block diagram illustrating a configuration of a radio transmission apparatus according Embodiment 4 of the invention;

FIG. 23 is a MCS selection table according to Embodiment 4 of the invention;

FIG. 24 is a block diagram illustrating a configuration of a radio transmission apparatus according Embodiment 5 of the invention;

FIG. 25 is an explanatory view of SIR margin according to Embodiment 5 of the invention; and

FIG. 26 is a block diagram illustrating a configuration of a radio transmission apparatus according Embodiment 6 of the invention.

### BEST MODE FOR CARRYING OUT THE INVENTION

Embodiments of the present invention will specifically be described below with reference to the accompanying drawings.

### Embodiment 1

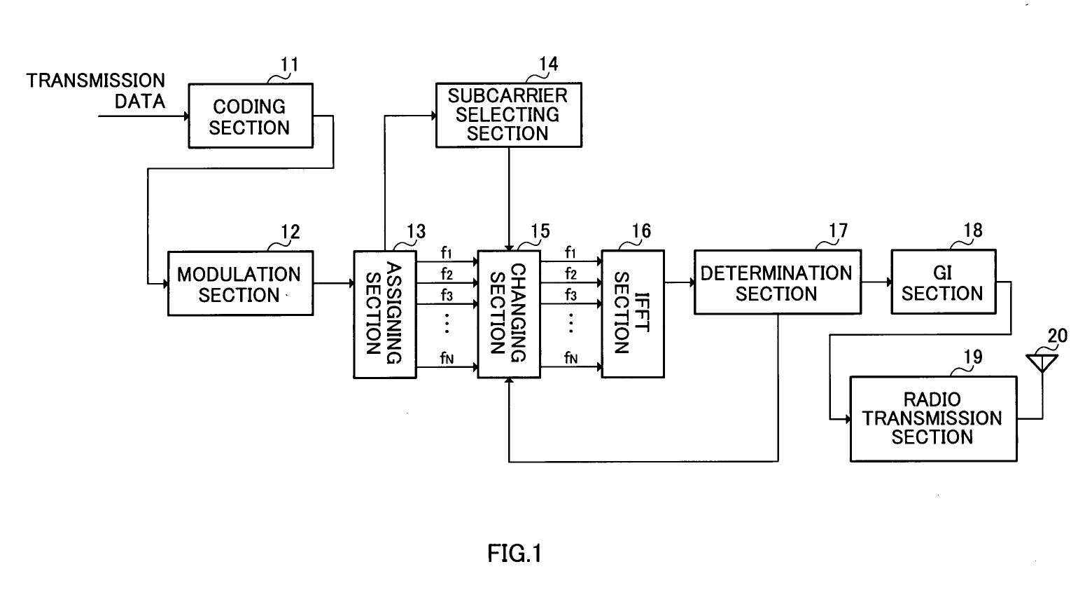

FIG. 1 is a block diagram illustrating the configuration of the radio transmission apparatus according Embodiment 1 of the present invention. The radio transmission apparatus shown in FIG. 1 has coding section 11, modulation section 12, assigning section 13, subcarrier selecting section 14, changing section 15, inverse fast Fourier transform (IFFT) section 16, determination section 17, guard interval (GI) section 18, radio transmission section 19, and antenna 20.

Coding section 11 performs error correcting coding on transmission data (bit sequence).

Modulation section 12 generates a symbol from the coded data, places the generated symbol at one of a plurality of signal points on the IQ plane, and thereby modulates the data. The plurality of signal points on the IQ plane are defined according to the modulation scheme used in modulation section 12, and this will be described later in detail.

Assigning section 13 transforms the modulated symbol input in series from modulation section 12 into parallel form and inputs the result to changing section 15. Whenever a number of symbols equivalent to a plurality of subcarriers constituting one OFDM symbol are input in series, assigning section 13 assigns the symbols to the plurality of subcarriers and inputs the result to changing section 15. Further, assigning section 13 inputs assignment information indicating which symbol is assigned to which subcarrier to subcarrier selecting section 14. Herein, the number of subcarriers constituting one OFDM symbol is assumed N (f₁ to f_{N}).

Based on the assignment information, subcarrier selecting section 14 selects subcarriers to be changed the phase and amplitude among subcarriers f₁ to f_{N}, and inputs the selection result to changing section 15. Subcarrier selecting section 14 selects, as the changing target, subcarriers other than subcarriers assigned relatively important information such as a pilot symbol, control data and so forth.

According to the determination result in determination section 17, which will be described later, changing section 15 changes the phase and amplitude of the subcarriers selected in subcarrier selecting section 14. The changing method will be described later. Changing section 15 inputs subcarriers f₁ to f_{N}, the phase and amplitude of which have been changed, to IFFT section 16.

IFFT section 16 transforms subcarriers f₁ to f_{N} input from changing section 15 from the frequency domain to time domain through the inverse fast Fourier transform, generates an OFDM symbol, which is a multicarrier signal, and inputs this OFDM symbol to determination section 17.

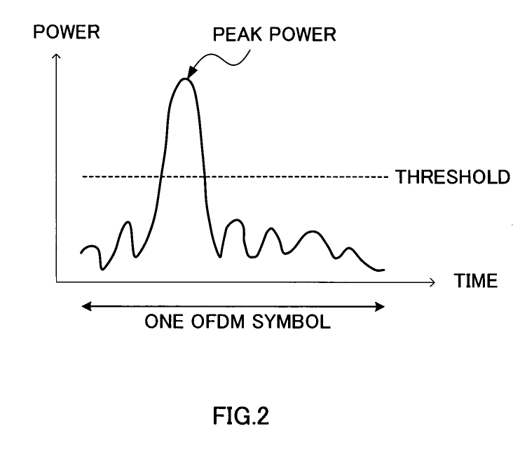

For the input OFDM symbol, determination section 17 measures the peak power relative to the average power shown in FIG. 2, and determines whether or not the peak power is greater than or equal to the threshold. As a result of the determination, when the peak power is less than the threshold, determination section 17 inputs the OFDM symbol to GI section 18. Meanwhile, when the peak power is equal to or greater than the threshold, determination section 17 sends changing instruction to changing section 15. According to this instruction, changing section 15 changes the phase and amplitude of the subcarriers selected in subcarrier selecting section 14 among the subcarriers f₁ to f_{N} input from assigning section 13.

Then, the OFDM symbol is attached a guard interval in GI section 18, processed by predetermined radio processing such as up-conversion and the like in radio transmission section 19, and transmitted by radio to a radio reception apparatus from antenna 20.

The signal point constellation on the IQ plane and the changing method in changing section 15 will next be described below.

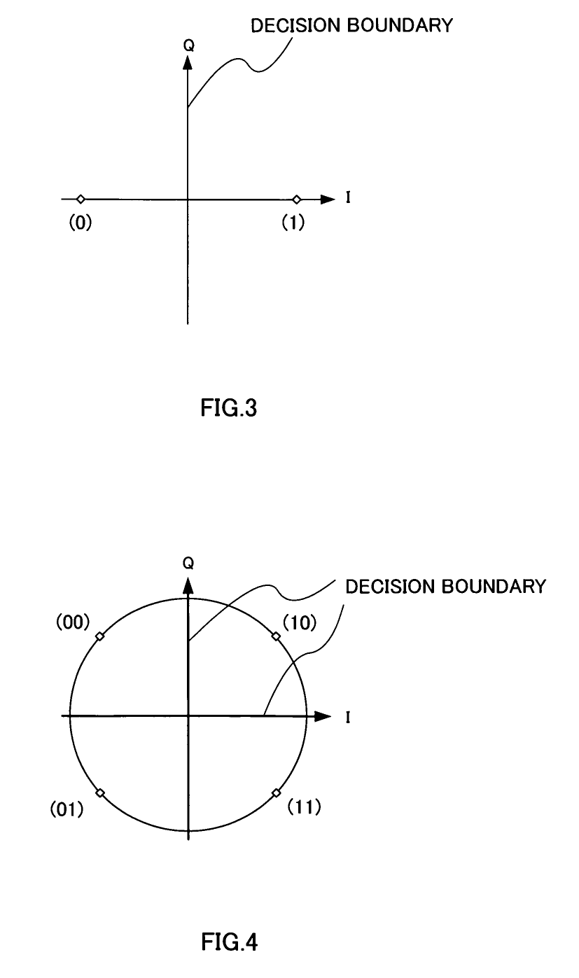

FIGS. 3 to 6 show the signal point constellations in BPSK (Binary Phase Shift Keying), QPSK (Quaternary Phase Shift Keying), 8PSK (Phase Shift Keying) and 16QAM (Quadrature Amplitude Modulation), respectively.

In BPSK, one symbol is comprised of one bit, and the signal point constellation is as shown in FIG. 3. In other words, in the radio transmission apparatus, a symbol modulated by BPSK is placed in one of two signal points. In this case, the decision boundary between the adjacent signal points is the Q axis. Accordingly, the radio reception apparatus decides a received symbol positioned in the region defined as I≧0 is “1”and a received symbol positioned in the region defined as I<0 is “0.”

In QPSK, one symbol is comprised of two bits, and the signal point constellation is as shown in FIG. 4. In other words, in the radio transmission apparatus, a symbol modulated by QPSK is placed in one of four signal points. In this case, the decision boundaries between the adjacent signal points are the I axis and Q axis. Accordingly, the radio reception apparatus decides that a received symbol positioned in the region defined as I≧0 and Q≧0 (first quadrant) is “10”, a received symbol positioned in the region defined as I<0 and Q≧0 (second quadrant) is “00”, a received symbol positioned in the region defined as I<0 and Q<0 (third quadrant) is “01”, and a received symbol positioned in the region defined as I≧0 and Q<0 (fourth quadrant) is “11”.

In 8PSK, one symbol is comprised of three bits, and the signal point constellation is as shown in FIG. 5. In other words, in the radio transmission apparatus, a symbol modulated by 8PSK is placed in one of eight signal points. In this case, the decision boundaries between adjacent signal points are the I axis, Q axis and the lines spaced π/4 apart from each of the I axis and Q axis. Accordingly, for example, the radio reception apparatus decides a received symbol positioned in the region defined as 0≦θ<π/4 is “001”, and a received symbol positioned in the region defined as π/4≦θ<π/2 is “010”.

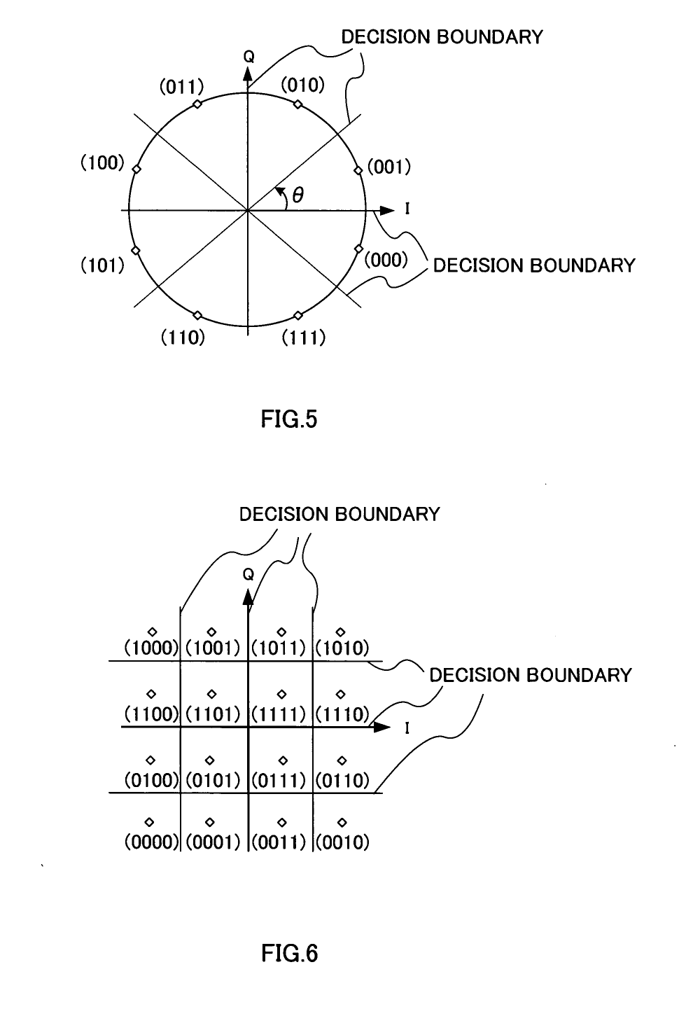

In 16QAM, one symbol is comprised of four bits, and the signal point constellation is as shown in FIG. 6. In other words, in the radio transmission apparatus, a symbol modulated by 16QAM is placed in one of sixteen signal points. In this case, the decision boundaries between adjacent signal points are the I axis, Q axis and the lines which are parallel with the I axis or Q axis and spaced an equal distance apart from respective signal points. For example, when the signal point constellation is I or Q=−3, −1, 1, 3, the decision boundaries between adjacent signal points are the I axis, Q axis, I=−2, 2 and Q=−2, 2. Accordingly, for example, the radio reception apparatus decides that a received symbol positioned in the region defined as 0≦I<2 and −2≦θ<0 is “0111”, and a received symbol positioned in the region defined as −2≦I<0 and Q≧2 is “1001”.

Then, changing section 15 changes the phase and amplitude of the subcarriers selected in subcarrier selecting section 14 within a range that does not cross the decision boundary between the signal points. For example, when the modulation scheme is BPSK and a symbol is placed in the signal point of “1”, changing section 15 changes the phase and amplitude of the subcarrier assigned the symbol within the range that does not cross the decision boundary with the signal point of “0”adjacent to the signal point of “1”(i.e. within the range of I≧0). When the modulation scheme is QPSK and a symbol is placed in a signal point of “10”, changing section 15 changes the phase and amplitude of the subcarrier assigned the symbol within the range that does not cross the decision boundaries respectively with the signal points of “11”and “00”adjacent to the signal point of “10”(i.e. within the range of I≧0 and Q≧0). When the modulation scheme is 8PSK and a symbol is placed in a signal point of “010”, changing section 15 changes the phase and amplitude of the subcarrier assigned the symbol within the range that does not cross the decision boundaries respectively with the signal points of “001”and “011” adjacent to the signal point of “010”(i.e. within the range of π/4≦θ<π/2). When the modulation scheme is 16QAM and a symbol is placed in the signal point of “1111”, changing section 15 changes the phase and amplitude of the subcarrier assigned the symbol within the range that does not cross the decision boundaries respectively with the signal points of “0111”, “1110”, “1011”, and “1101”adjacent to the signal point of “1111”(i.e. within the range of 0≦I<2 and 0≦Q<2).

Changing section 15 thus changes the phase and amplitude of a subcarrier is for the following reason: That is, when the radio reception apparatus makes a decision on a received symbol, the apparatus makes a region decision as described above. Accordingly, by changing the phase and amplitude of subcarriers, even when a symbol is received in a position somewhat shifted from the signal point constellation as shown in FIG. 3 to FIG. 6 (ideal signal point constellations), as long as the shifted position is within a range that does not cross the decision boundary with the adjacent signal point, the radio reception apparatus is able to determine the received symbol accurately. Further, since the radio reception apparatus determines the received symbol by region decision such as described above, as long as the phase and amplitude of the subcarrier are changed within a range that does not cross the decision boundary with the adjacent signal point, the radio reception apparatus is able to determine received symbols accurately using conventional method without having information regarding the change amount from the radio transmission apparatus, so that it is possible to avoid degradation of transmission efficiency due to transmission of the report signal. In addition, by changing section 15 shifting the signal point, such a symbol arises that exceeds the decision boundary due to effects of noise and like on the propagation path. Thus the reliability of the symbol deteriorates, and the probability of occurrence of an error is increased. However, since coding section 11 performs error correcting coding, the error can be corrected by error correcting decoding in the radio reception apparatus.

The changing method in changing section 15 will be described below more specifically.

Examples 1 to 6 assume the case where the modulation scheme is QPSK, and modulation section 12 places a symbol at the signal point of “10”in FIG. 4, i.e. the signal point has the amplitude and power (square of the amplitude) of 1 and coordinates (1/√2, 1/√2)

### EXAMPLE 1

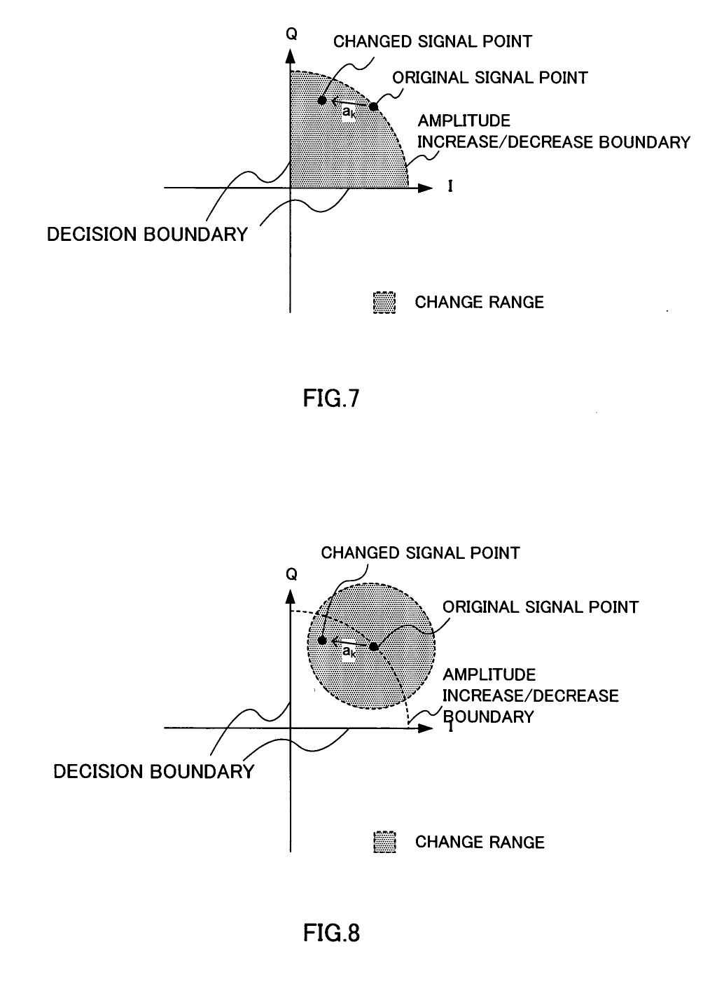

In Example 1, the phase and amplitude of a subcarrier is changed in the change range shown in FIG. 7. More specifically, changing section 15 multiplies the subcarrier selected in subcarrier selecting section 14 by aₖ as shown in following Equation (1):
aₖp·e^{jθ} (1)

where p is a variable for changing the amplitude and is defined as 0<p<1, θ is a variable for changing the phase and is defined as −π/4<θ<π/4, and these are both random variables that change per subcarrier. k is 1, 2, . . . , N (N is the total number of subcarriers contained in one OFDM symbol). By thus changing θ randomly and changing the phase of each of subcarriers, it is possible to make the subcarriers out of phase, and, as a result, it is possible to suppress peak power of the OFDM symbol. Further, since p is defined as 0<p<1, the change range lies inside the amplitude increase/decrease boundary (part of a circle with a radius of 1) , and a subcarriers after the change always has lower amplitude and power than the subcarrier before the change. The transmission power of an OFDM symbol is determined as average power of a plurality of subcarriers contained in the OFDM symbol, and therefore, according to Example 1, it is possible to further reduce the transmission power of an OFDM symbol, as the number of changing target subcarriers increases. By reducing the transmission power, it is possible to reduce interference imposed on other communications. Further, the transmission power that is reduced can be allocated to other communication, and therefore it is possible to enhance the overall transmission efficiency of the system. In other words, in Example 1, the peak power is suppressed by randomly changing the phase of each subcarrier, while the transmission power of a multicarrier signal is reduced by decreasing the amplitude of each subcarrier.

### EXAMPLE 2

In Example 2, the phase and amplitude of a subcarrier is changed in the change range (within the range of a circle with the original signal point as the center) shown in FIG. 8. More specifically, changing section 15 adds aₖ shown in above-mentioned Equation (1) to the subcarrier selected in subcarrier selecting section 14. However, in Example 2, where p is defined as 0<p<1/√2, θ is defined as 0<θ≦2π, and these are both random variables that change per subcarrier. In Example 2, since the change range has a larger area outside the amplitude increase/decrease boundary than inside the amplitude increase/decrease boundary, the transmission power of the OFDM symbol increases with probability. By thus increasing the transmission power of an OFDM symbol, the error rate in the radio reception apparatus can be decreased, as compared with Example 1.

### EXAMPLE 3

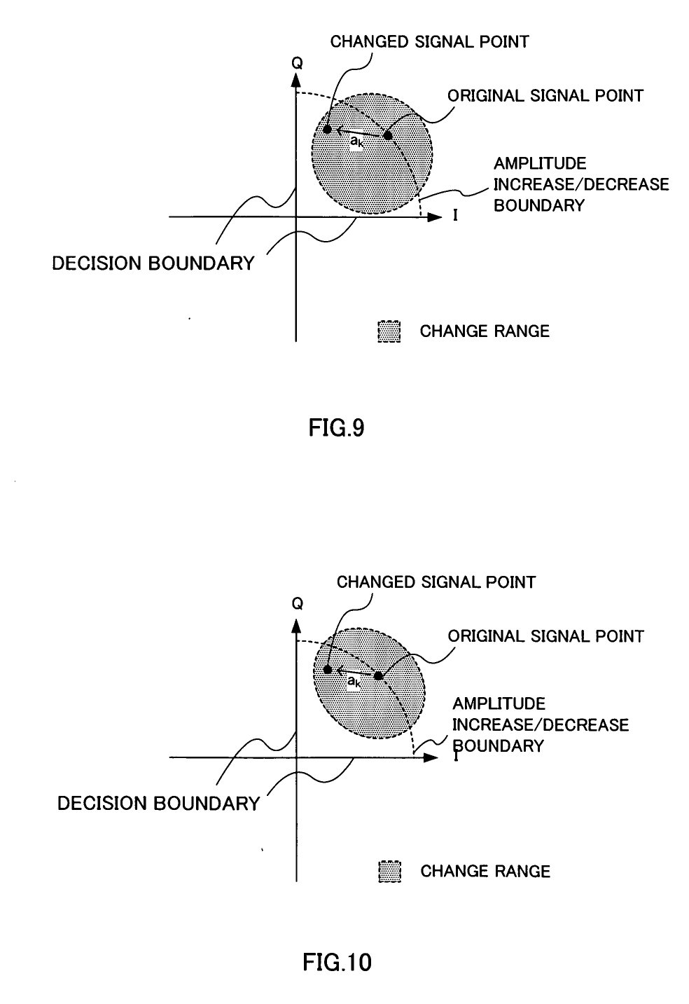

In Example 3, the phase and amplitude of a subcarrier is changed in the change range (within the range that the center of the circle in Example 2 is shifted toward the I axis and Q axis) shown in FIG. 9. More specifically, changing section 15 multiplies the subcarrier selected in subcarrier selecting section 14 by the constant Sₖ (0<Sₖ≦1) and adds the resultant to aₖ shown in above-mentioned Equation (1). In Example 3, where p is a constant defined as 0<p≦sₖ/√2, and θ is a variable defined as 0<θ≦2π and is random per subcarrier. In Example 3, since the change range has a larger area inside the amplitude increase/decrease boundary than outside the amplitude increase/decrease boundary, the transmission power of the OFDM symbol decreases with probability.

### EXAMPLE 4

In Example 4, the phase and amplitude of a subcarrier is varied in the change range (within the range such that the circle in Example 3 is made an ellipse) as shown in FIG. 10. As in Example 3, in Example 4, since the change range has a larger area inside the amplitude increase/decrease boundary than outside the amplitude increase/decrease boundary, the transmission power of the OFDM symbol decreases with probability.

### EXAMPLE 5

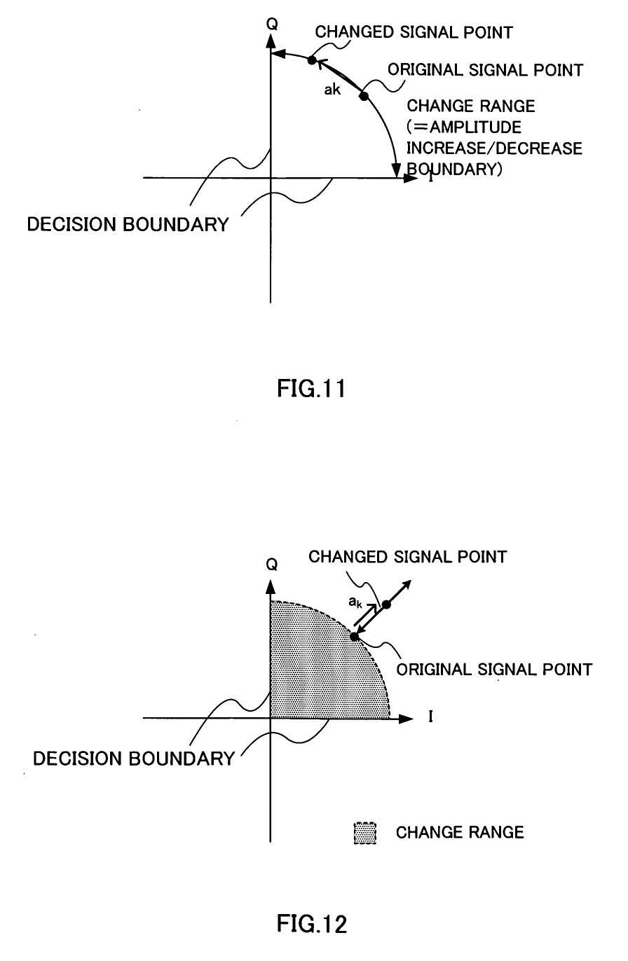

In Example 5, the phase of a subcarrier is changed in the change range (on the amplitude increase/decrease boundary) shown in FIG. 11. In other words, only the phase is changed without changing the amplitude. More specifically, changing section 15 multiplies the subcarrier selected in subcarrier selecting section 14 by aₖ shown in following Equation (2):
aₖ=e^{jθ} (2)

where θ is a variable defined as −π/4<θ<π/4 and is random per subcarrier. In this Example 5, it is possible to suppress the peak power while maintaining the transmission power of the OFDM symbol.

### EXAMPLE 6

In Example 6, the phase and amplitude of a subcarrier is varied in the change range shown in FIG. 12. In Example 6, the amplitude may be increased while p is set at p>0 in Example 1. When the amplitude is increased, only the amplitude of the original signal point is increased without changing the phase. In the case where the phase is changed when the amplitude is increased, OFDM symbol transmission power increases and the SNR (Signal to Noise Ratio) deteriorates. This causes inefficiency and the above is done so as to prevent this inefficiency.

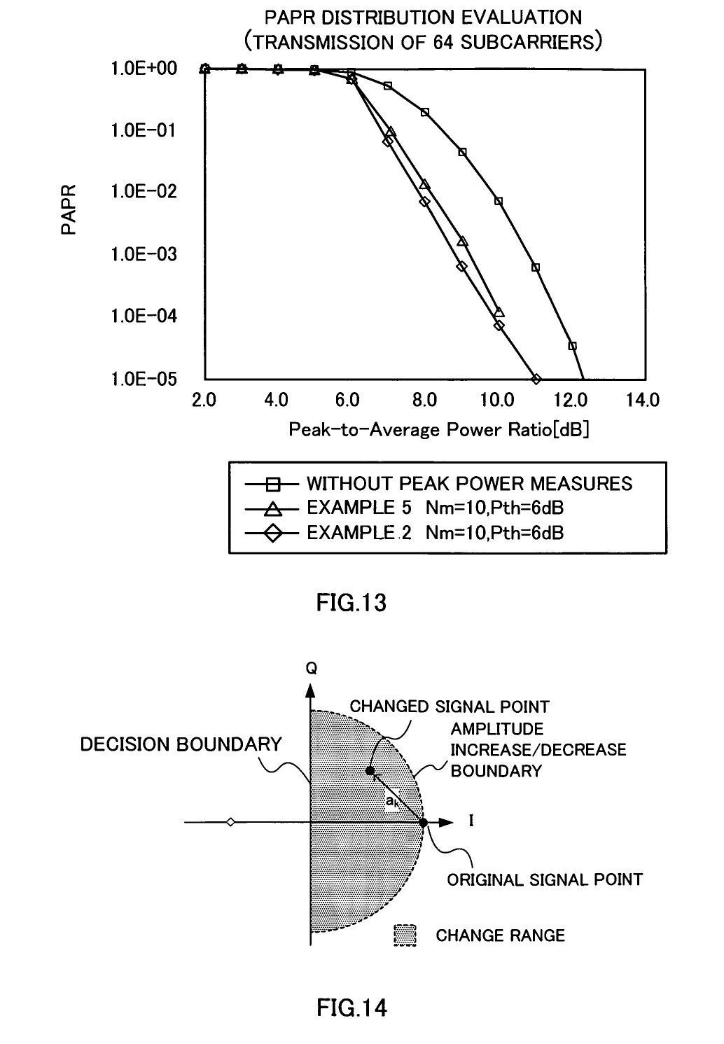

FIG. 13 shows simulation results (peak power occurrence probability distribution evaluation: PAPR distribution evaluation) when the change method of Examples 2 and 5 are used. By looking at the peak power occurrence probability of 1%, it is understood that the peak power decreases by 2 dB in Example 2 and 1.6 dB in Example 5, as compared with the case that peak power measures are not taken.

Examples 7 to 11 described below are those in case where the modulation scheme is BPSK, 8PSK or 16QAM, and correspond to Example 1 in the case of QPSK. In other words, in each of following Examples 7 to 11, the phase of each subcarrier is changed randomly to suppress peak power, while the amplitude of each subcarrier is decreased to reduce the transmission power of the multicarrier signal. Accordingly, in any one of following Examples 7 to 11, as in Example 1, the change range is surrounded by decision boundaries with adjacent symbols and is within a range in which the amplitude does not increase.

### EXAMPLE 7

Example 7 shown in FIG. 14 is an example in the case where the modulation scheme is BPSK and modulation section 12 places a symbol at the signal point of “1”in FIG. 3. In Example 7, the phase and amplitude of a subcarrier is varied in the change range shown in FIG. 14.

### EXAMPLE 8

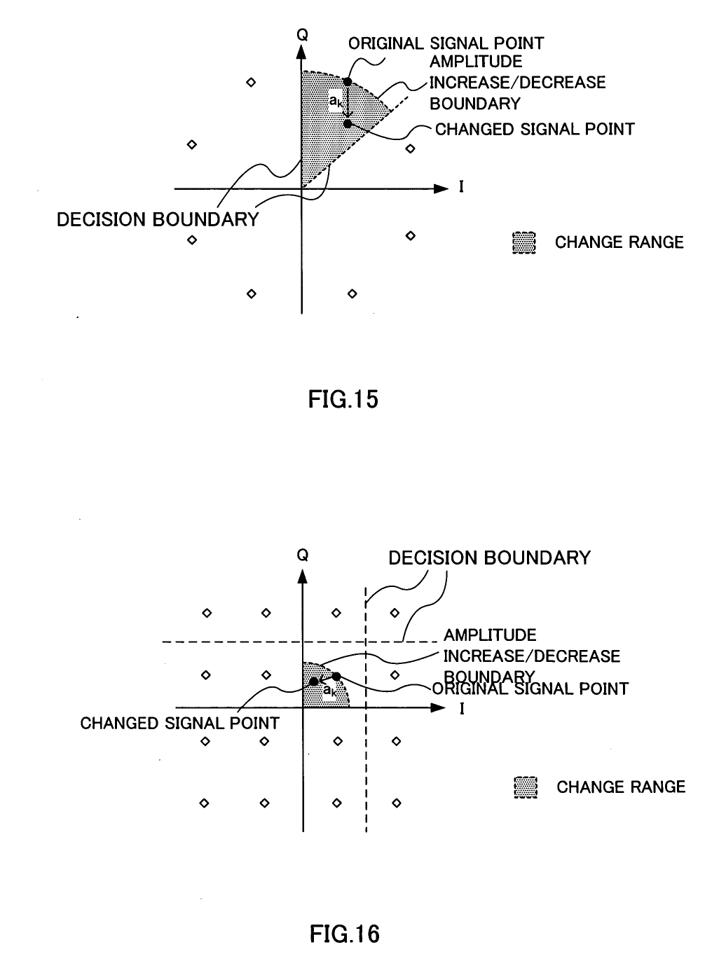

Example 8 shown in FIG. 15 is an example in the case where the modulation scheme is 8PSK and modulation section 12 places a symbol at the signal point of “010”in FIG. 5. In Example 8, the phase and amplitude of a subcarrier are changed in the change range shown in FIG. 15.

### EXAMPLE 9

Example 9 shown in FIG. 16 is an example in the case where the modulation scheme is 16QAM and modulation section 12 places a symbol at the signal point of “1111”in FIG. 6. In Example 9, the phase and amplitude of a subcarrier are changed in the change range as shown in FIG. 16.

### EXAMPLE 10

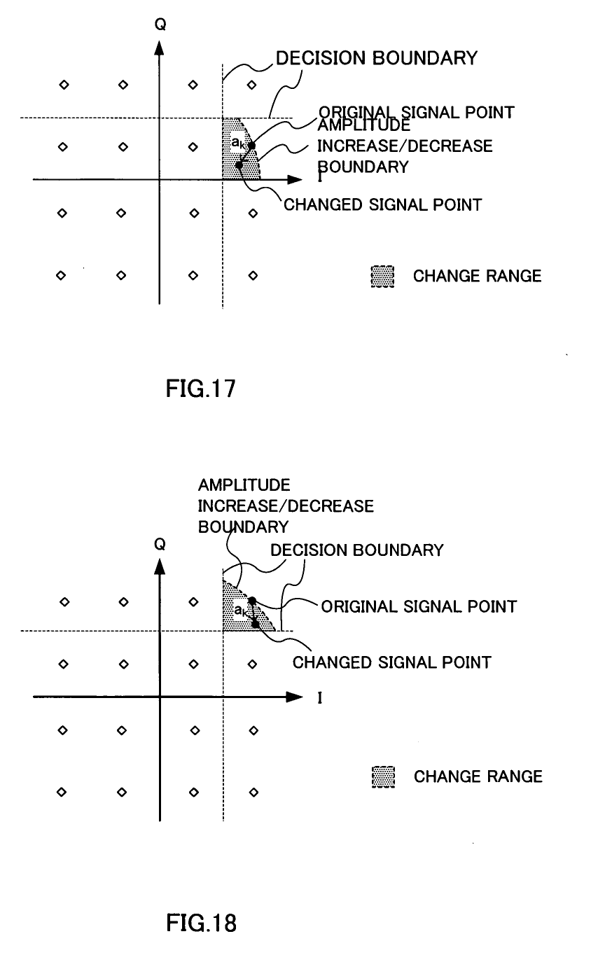

Example 10 shown in FIG. 17 is an example in the case where the modulation scheme is 16QAM and modulation section 12 places a symbol at the signal point of “1110”in FIG. 6. In Example 10, the phase and amplitude of a subcarrier are changed in the change range shown in FIG. 17.

### EXAMPLE 11

Example 11 as shown in FIG. 18 is that in the case where the modulation scheme is 16QAM and modulation section 12 places a symbol at a signal point of “1010”in FIG. 6. In Example 11, the phase and amplitude of a subcarrier is varied in the change range shown in FIG. 18.

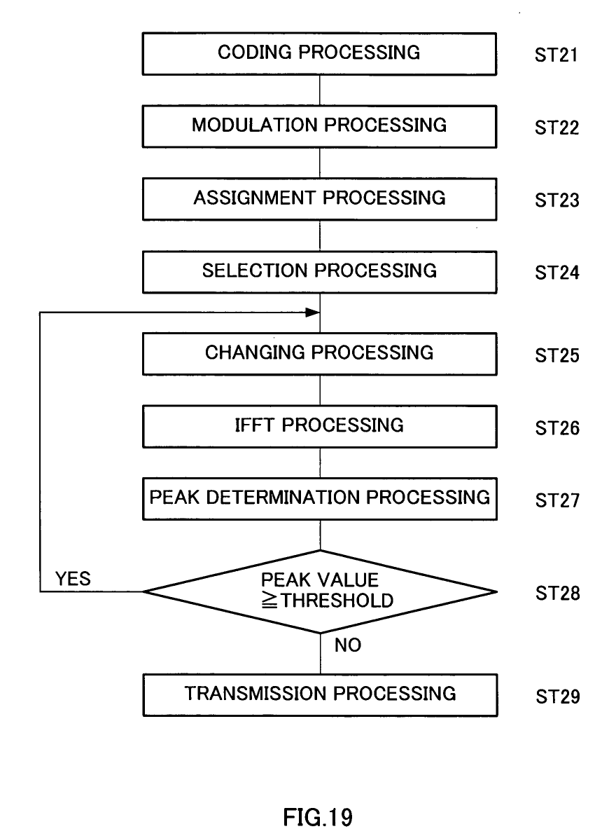

The processing flow in the radio transmission apparatus will be described next with reference to FIG. 19. In step (ST)21, coding section 11 encodes transmission data (bit sequence) (coding processing). In ST22, modulation section 12 modulates the coded data (modulation processing). In ST23, assigning section 13 assigns modulated symbols to respective subcarriers (assignment processing). In ST24, subcarrier selecting section 14 selects subcarriers to be changed the phase and amplitude (selection processing). In ST25, changing section 15 changes the phase and amplitude of the selected subcarrier (changing processing). In ST26, IFFT section 16 performs IFFT processing to generate an OFDM symbol (IFFT processing). In ST27 and ST28, determination section 17 determines whether or not the peak power of the OFDM symbol is equal to or greater than a threshold (peak determination processing), and, when the peak power is equal to or greater than the threshold, the processing flow returns to the changing processing of ST25, while, when the peak power is less than the threshold, GI section 18 adds a guard interval and radio transmission section 19 transmits the OFDM symbol in ST 29 (transmission processing).

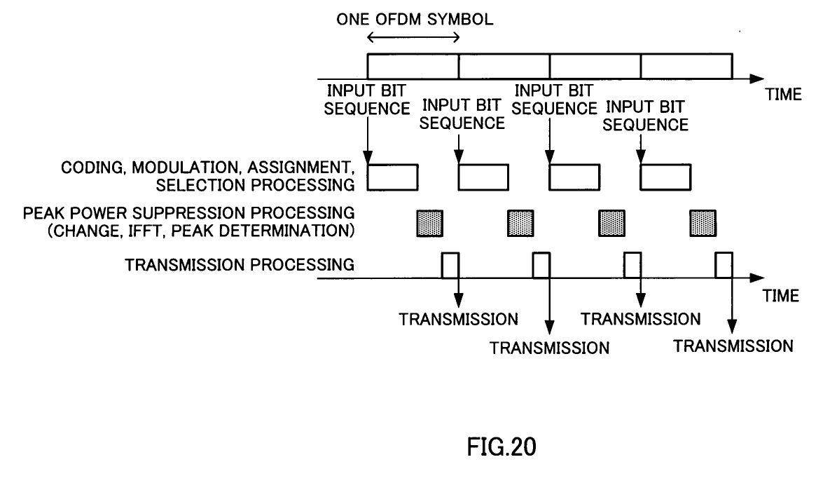

As can be seen from the processing flow, the changing processing to the peak determination processing are repeated until the peak power becomes less than the threshold. When the peak power is equal to or greater than the threshold, changing section 15 changes the change amount every time, and changes the phase and amplitude of each subcarrier. In other words, the changing processing is repeated until the peak power becomes less than the threshold. Therefore, changing section 15 has a buffer and holds subcarriers input from assigning section 13 for a predetermined time. However, as shown in the processing timing of FIG. 20, the time allowed for peak power suppression processing (repetition of the changing processing, IFFT processing and peak determination processing: repetition of ST25 to ST28) during the period after transmission data (bit sequence) is input in coding section 11 until the OFDM symbol is transmitted, is limited. Accordingly, the above repetition processing for peak power suppression is cut off at the maximum when transmission processing in ST29 is started. At this point, when the peak power is still equal to or greater than the threshold, the radio transmission apparatus selects the OFDM symbol of the lowest peak power in the repetition processing up till then and transmits the selected OFDM symbol. In this transmission, the power of the OFDM symbol may be limited to the level of the threshold.

In addition, since an OFDM symbol having the peak power originally less than the threshold does not need changing processing in changing section 15, it may be possible that, in the processing flow shown in FIG. 19, ST26 to ST28 are performed without performing ST25, and when the peak power is equal to or greater than the threshold, ST25 is performed for the first time.

Thus, according to this Embodiment, there is no need to transmit information regarding the phase to the radio reception apparatus even when the phase of the subcarrier is varied to suppress the peak power, and it is thus possible to prevent the transmission efficiency from deteriorating. Further, a subcarrier not to be transmitted does not exist, and it is thereby possible to suppress the peak power without degrading the throughput.

### Embodiment 2

In this Embodiment, only the operation of changing section 15 differs from Embodiment 1, and referring to FIG. 1 again, described below is the operation of changing section 15 according to this Embodiment.

In the repetition of ST25 to ST28 explained above using FIG. 19, when the peak power is equal to or greater than the threshold, changing section 15 increases the change amount gradually in above Equation (1) and changes the phase and amplitude of each subcarrier. More specifically, changing section 15 selects one of the following levels of change amounts in Equation (1). In addition, the following examples of levels of change amounts are in the case of using QPSK as a modulation scheme.

Level 1: 0.75<p≦1.0, |θ|<π/16

Level 2: 0.5<p≦0.75, π/16≦|θ|<π/12

Level 3: 0.25<p≦0.5, π/12≦|θ|<π/8

Level 4: 0<p≦0.25, π/8≦|θ|<π/4

At this point, changing section 15 increases the level of the change amount gradually according to the number of repetitions such that level 1 is used in the first changing processing, level 2 is used in the second changing processing, and level 3 is used in the third changing processing, and soon. As the level of the change amount is higher, the phase and amplitude of a subcarrier can be changed greater. Then, when determination section 17 determines that the peak power is less than the threshold, transmission processing is performed.

Thus, according to this Embodiment, change amounts of the peak and amplitude are increased gradually when the peak power is equal to or greater than the threshold and the OFDM symbol is transmitted at the time the peak power becomes less than the threshold. It is thereby possible to change the phase and amplitude of a subcarrier with a minimum change amount required for the peak power to be less than the threshold. Accordingly, it is possible to suppress the peak power while minimizing deterioration in the error rate due to variations in the phase and amplitude.

### Embodiment 3

This Embodiment differs from above Embodiment 1 in performing a plurality of processing in changing section 15 and IFFT section 16 in parallel to select an OFDM symbol with the lowest peak power.

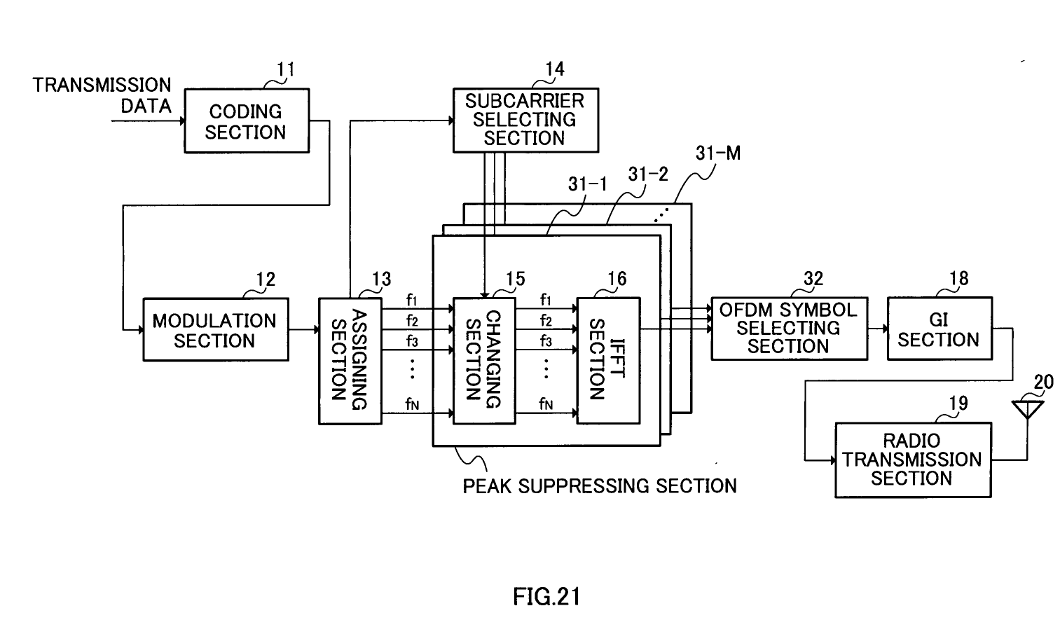

FIG. 21 is a block diagram illustrating the configuration of the radio transmission apparatus according to Embodiment 3 of the present invention. In addition, descriptions are omitted on sections in FIG. 21 with the same operation as that in FIG. 1 (Embodiment 1).

The radio transmission apparatus according to this Embodiment is provided with a plurality of peak suppressing sections 31-1 to 31-M, each comprised of changing section 15 and IFFT section 16. Changing sections 15 of peak suppressing sections 31-1 to 31-M change the phase and amplitude of a subcarrier selected in subcarrier selecting section 14 among subcarriers f, to f_{N} input from assigning section 13. At this point, changing sections 15 of peak suppressing section 31-1 to 31-M change the phase and amplitude of the same subcarrier with different change amounts, respectively. Accordingly, peak power varies between OFDM symbols generated in IFFT sections 16 of peak suppressing sections 31-1 to 31-M. Thus the generated M OFDM symbols are input to OFDM symbol selecting section 32 in parallel. Then, OFDM symbol selecting section 32 selects the OFDM symbol with the lowest peak power among the M OFDM symbols and input the OFDM symbol to GI section 18.

Thus, according to this Embodiment, a plurality of changing processing are performed in parallel as an alternative to the repeated changing processing performed in Embodiment 1, so that it is possible to suppress the peak power in a short time as compared with Embodiment 1.

In addition, the plurality of M changing sections 15 may change the phases and amplitudes of different subcarriers. In this way, it is expected that peak suppressing sections 31-1 to 31-M output M OFDM symbols with more random PAPR.

### Embodiment 4

This Embodiment describes the case of performing adaptive modulation per subcarrier.

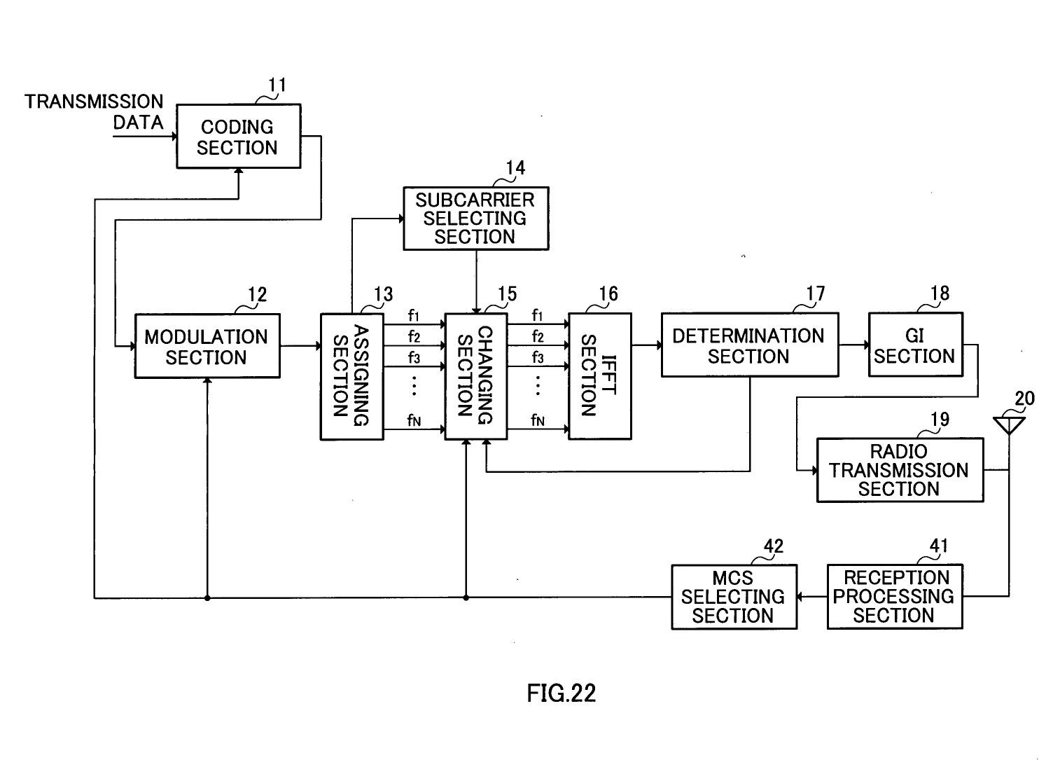

FIG. 22 is a block diagram illustrating the configuration of the radio transmission apparatus according to Embodiment 4 of the present invention. In addition, descriptions are omitted on sections in FIG. 22 with the same operation as that in FIG. 1 (Embodiment 1).

A radio reception apparatus receiving an OFDM symbol transmitted from antenna 20 measures reception SIR (reception quality) per subcarrier, and reports received SIR value per subcarrier as a report signal to the radio transmission apparatus in FIG. 22. The report signal received via antenna 20 undergoes reception processing (radio processing, demodulation and the like) in reception processing section 41, and the received SIR value per subcarrier is input to MCS (Modulation and Coding Scheme) selecting section 42.

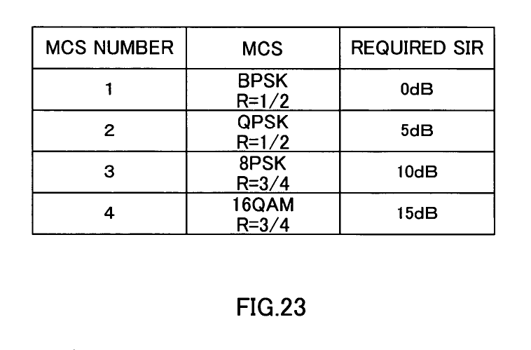

MCS selecting section 42 selects a modulation scheme and coding rate, referring to the table shown in FIG. 23. MCS selecting section 42 selects the modulation scheme and coding rate such that the received SIR value reported from the radio reception apparatus fulfills the required SIR value. For example, when the received SIR value reported from the radio reception apparatus is 7 dB, MCS number 2 (modulation scheme: QPSK, coding rate R=½) is selected. When the received SIR value reported from the radio reception apparatus is 14 dB, MCS number 3 (modulation scheme: 8PSK, coding rate R=¾) is selected. MCS selecting section 42 performs this selection per subcarrier, and then inputs the MCS number selected per subcarrier to coding section 11, modulation section 12 and changing section 15.

Coding section 11 performs coding with the coding rate in accordance with the input MCS number, and modulation section 12 performs adaptive modulation per subcarrier with the modulation scheme in accordance with the input MCS number.

Then, changing section 15 decreases the change amount of the phase and amplitude for the subcarrier with a higher MCS number. In other words, changing section 15 decreases the change amount in changing the phase and amplitude of each subcarrier, as the M-ary modulation level used in modulation section 12 is greater. More specifically, using the levels 1 to 4 described in above Embodiment 2, changing section 15 changes the phase and amplitude of each subcarrier with level 4 in the case that the modulation scheme is BPSK, with level 3 in the case that the modulation scheme is QPSK, with level 2 in the case that the modulation scheme is 8PSK, or with level 1 in the case that the modulation scheme is 16QAM.

As can be seen from FIGS. 3 to 6, since the distance between adjacent signal points is shorter as the M-ary modulation level is greater, the possible change amount becomes smaller. Accordingly, in the radio communication system where adaptive modulation is performed per subcarrier, according to this Embodiment, it is possible to change the phase and amplitude of each subcarrier with a suitable change amount (change amount in the range that does not cross the decision boundary with the adjacent signal point) according to the modulation scheme, and to decrease the error rate.

### Embodiment 5

This Embodiment describes the case of performing adaptive modulation per subcarrier as in above Embodiment 4.

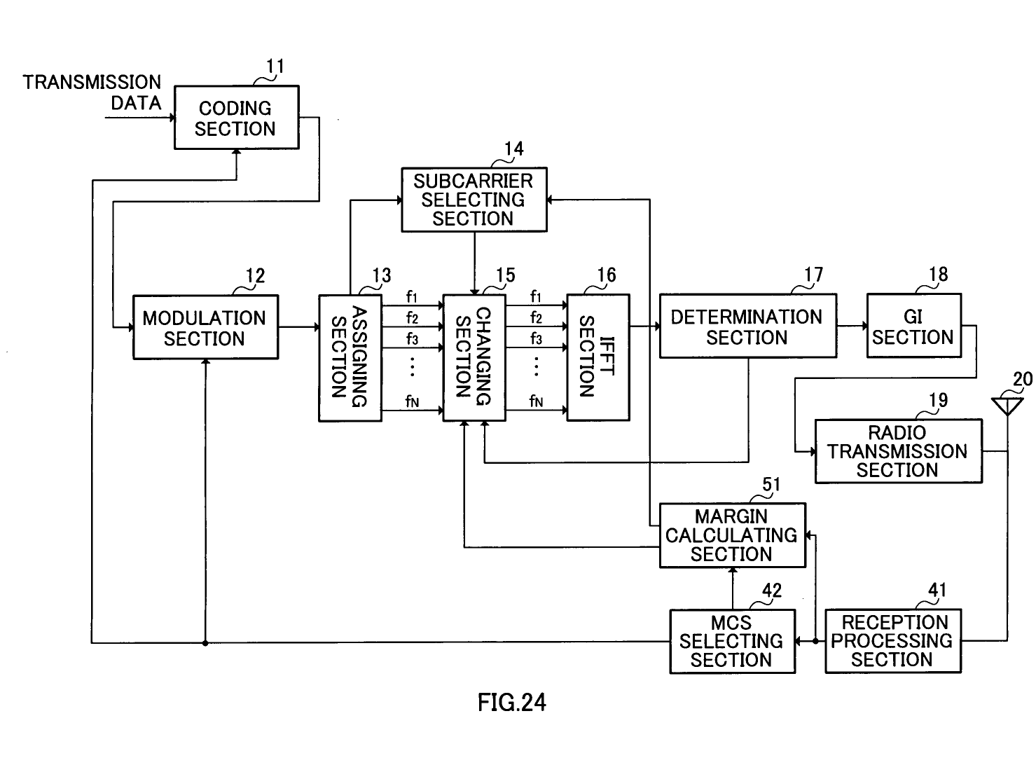

FIG. 24 is a block diagram illustrating a configuration of a radio transmission apparatus according to Embodiment 5 of the present invention. Descriptions are omitted on sections in FIG. 24 with the same operation as those in FIG. 1 (Embodiment 1) and FIG. 22 (Embodiment 4).

A report signal which is transmitted from the radio reception apparatus and received via antenna 20 undergoes reception processing in reception processing section 41, and the received SIR value per subcarrier is input to MCS selecting section 42 and margin calculating section 51.

MCS selecting section 42 inputs the MCS number per subcarrier selected as in above-mentioned Embodiment 4 to coding section 11 and modulation section 12. Further, MCS selecting section 42 inputs the required SIR value for the MCS per subcarrier selected as in above Embodiment 4 to margin calculating section 51.

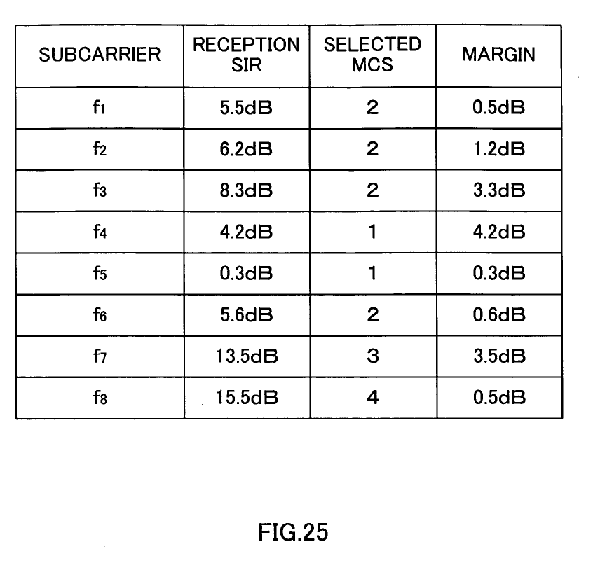

As shown in FIG. 25, margin calculating section 51 calculates the difference between the received SIR value reported from the radio reception apparatus and the required SIR value for MCS selected in MCS selecting section 42 (received SIR value−required SIR value), i.e. the SIR margin per subcarrier. Then, margin calculating section 51 inputs the calculated SIR margin to subcarrier selecting section 14 and changing section 15. For example, with respect to subcarrier f₃ in FIG. 25, since the MCS of MCS number 2 (modulation scheme: QPSK, coding rate R=½) is selected, the required SIR value is 5 dB from FIG. 23. Meanwhile, the received SIR value of subcarrier f₃ reported from the radio reception apparatus is 8.3 dB from FIG. 25. Accordingly, margin calculating section 51 calculates the SIR margin for subcarrier f₃ as 3.3 dB.

Subcarrier selecting section 14 selects a subcarrier with an SIR margin equal to or greater than a threshold, and inputs the selection result to changing section 15. Accordingly, in changing section 15, among a plurality of subcarriers contained in one OFDM symbol, only a subcarrier such that a difference between the reception SIR in the radio reception apparatus and the required SIR for the modulation scheme used in modulation section 12 is equal to or greater than the threshold is subject to change. For example, when the threshold is 2.5 dB for the SIR margin shown in FIG. 25, subcarriers f₃, f₄, and f₇ among subcarriers f₁ to f₈ are subject to change.

Further, with respect to the subcarrier selected in subcarrier selecting section 14, changing section 15 determines the change amount according to the size of the SIR margin. For example, in Example 2 in above Embodiment 1, when the SIR margin is 3 dB, p is a random variable defined as 0<p<√0.5. When such p is set, deterioration in SNR due to the variation of the amplitude is 3 dB or less, and the radio reception apparatus is capable of receiving signals with the required PER (Packet Error Rate) or less. For more general descriptions, assuming the SIR margin as M[dB], p is set 0<p<10^{M/20} in above Equation (1). Then, by adding aₖ thus obtained from Equation (1) to the subcarrier selected in subcarrier selecting section 14, the radio reception apparatus is capable of receiving signals with the required PER or less in addition to suppressing the peak power.

In addition, the threshold of the SIR margin is set in consideration of SIR fluctuation predicted in a subsequent transmission frame. In other words, when the time variation of fading is fast and it is predicted that SIR fluctuates by 3 dB in the subsequent transmission frame, the threshold is set at 3 dB. In addition, the algorithm for predicting the SIR fluctuation includes methods of averaging earlier variations, using a linear filter and the like. Further, the threshold can be varied according to the error status in the radio reception apparatus. For example, the threshold is increased by 0.5 dB when a packet has an error, while the threshold is decreased by 0.5 dB when a packet has no error. Herein, the radio reception apparatus reports the presence or absence of the error of a received packet using an ACK/NACK signal to the radio transmission apparatus, and the radio transmission apparatus is thus capable of recognizing the presence or absence of the packet error. In this case, the ACK/NACK signal received in reception processing section 41 is output to margin calculating section 51.

Thus, according to this Embodiment, since a changing target is a subcarrier with an SIR margin equal to or greater than a threshold, the changing target can be set on only a subcarrier that does not cause an error even when its phase and amplitude is changed. Further, since the change amount is determined according to the size of the SIR margin, it is possible to change the phase and amplitude in the range where an error is not caused. It is thus possible to prevent the error occurrence due to phase and amplitude fluctuations, and the transmission efficiency can thereby be prevented from degrading due to retransmission.

### Embodiment 6

This Embodiment describes the case where transmission data (bit sequence) is coded using systematic codes such that turbo codes and the like as error correcting codes.

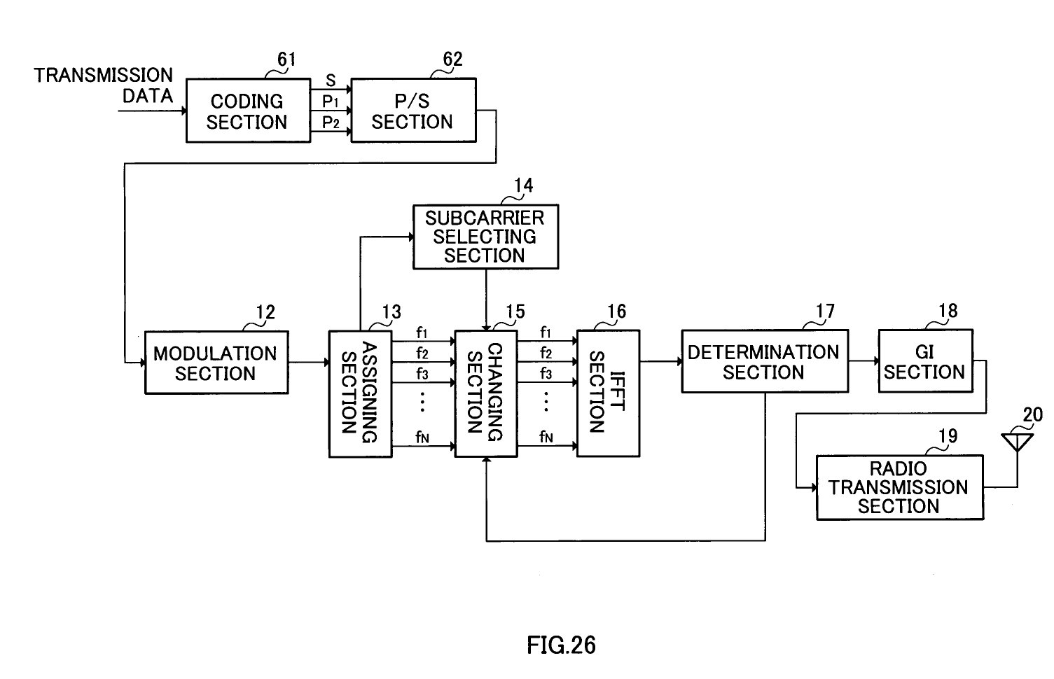

FIG. 26 is a block diagram illustrating the configuration of the radio transmission apparatus according to Embodiment 6 of the present invention. Descriptions are omitted on sections in FIG. 26 with the same operation as that in FIG. 1 (Embodiment 1).

Coding section 61 performs error correcting coding on transmission data (bit sequence) using systematic codes such as turbo codes and the like. By coding the transmission bit sequence using systematic codes, coding section 61 generates a systematic bit S that is a transmission bit itself and parity bit P that is a redundant bit. Herein, since the coding rate R is ⅓ (R=⅓), one systematic bit S and two parity bits P₁ and P₂ are generated for one transmission bit. The generated systematic bit S and parity bits P₁ and P₂ are input to P/S section 62 with the three bits in parallel.

P/S section 62 transforms input parallel bit sequence into a serial sequence, and inputs S, P₁ and P₂ in this order to modulation section 12.

Modulation section 12 modulates the input systematic bit S and parity bits P₁ and P₂ to generate a symbol. The symbol generated here includes three kinds of symbols, namely, a symbol comprised of only the systematic bit, a symbol comprised of the systematic bit and the parity bit, and a symbol comprised of only the parity bit. The modulated symbol is input to assigning section 13.

The operation of assigning section 13 is the same as in above Embodiment 1.

Herein, the systematic bit is the transmission bit itself and the parity bit is redundant bit. Therefore, in the radio reception apparatus, the influence on BER deterioration (Bit Error Rate) is not significant when erroneous determination is made on the symbol comprised of only the parity bit, while the influence on BER deterioration is significant when erroneous determination is made on the symbol including the systematic bit.

Therefore, based on assignment information, subcarrier selecting section 14 selects a subcarrier assigned the symbol comprised of only the parity bit from the above three symbols from among subcarriers f₁ to f_{N} as a subcarrier to be changed the phase and amplitude. Then, selecting section 14 inputs the selection result to changing section 15. Accordingly, in changing section 15, only the subcarrier assigned the symbol comprised of only the parity bits is subject to change among a plurality of subcarriers contained in one OFDM symbol.

Thus, according to this Embodiment, the quality of the systematic bit which has greater significance in error correction coding, does not degrade, so that it is possible to prevent BER deterioration and suppress peak power.

In addition, each of functional blocks employed in the description of each of aforementioned Embodiments may typically be implemented as an LSI constituted by an integrated circuit. These may be individual chips or partially or totally contained on a single chip.

“LSI” is adopted here but this may also be referred to as an “IC”, “system LSI”, “super LSI”, or “ultra LSI” depending on differing extents of integration.

Further, the method of integrating circuits is not limited to the LSI's, and implementation using dedicated circuitry or general purpose processor is also possible. After LSI manufacture, utilization of FPGA (Field Programmable Gate Array) or a reconfigurable processor where connections or settings of circuit cells within an LSI can be reconfigured is also possible.

Furthermore, if integrated circuit technology comes out to replace LSI's as a result of the advancement of semiconductor technology or derivative other technology, it is naturally also possible to carry out function block integration using this technology. Application in biotechnology is also possible.

The present application is based on Japanese Patent Application No. 2003-403415, filed on Dec. 2, 2003, the entire content of which is expressly incorporated by reference herein.

### INDUSTRIAL APPLICABILITY

The present invention is suitable for use in a radio communicating base station apparatus, radio communication mobile station apparatus and the like used in mobile communication systems.

FIG. 1 FIG. 21 FIG. 22 FIG. 24 FIG. 26

TRANSMISSION DATA
11 CODING SECTION
12 MODULATION SECTION
13 ASSIGNING SECTION
14 SUBCARRIER SELECTING SECTION
15 CHANGING SECTION
16 IFFT SECTION
17 DETERMINATION SECTION
18 GI SECTION
19 RADIO TRANSMISSION SECTION
   FIG. 2
POWER
PEAK POWER
THRESHOLD
TIME
ONE OFDM SYMBOL
   FIG. 3˜FIG. 6.
DECISION BOUNDARY
   FIG. 7˜FIG. 12 FIG. 14˜FIG. 18
ORIGINAL SIGNAL POINT
CHANGED SIGNAL POINT
AMPLITUDE INCREASE/DECREASE BOUNDARY
DECISION BOUNDARY
CHANGE RANGE
   FIG. 13
PAPR DISTRIBUTION EVALUATION
TRANSMISSION OF 64 SUBCARRIERS
WITHOUT PEAK POWER MEASURES
EXAMPLE 5
EXAMPLE 2
   FIG. 19
ST21 CODING PROCESSING
ST22 MODULATION PROCESSING
ST23 ASSIGNMENT PROCESSING
ST24 SELECTION PROCESSING
ST25 CHANGING PROCESSING
ST26 IFFT PROCESSING
ST27 PEAK DETERMINATION PROCESSING
ST28 PEAK VALUE≧THRESHOLD
ST29 TRANSMISSION PROCESSING
   FIG. 20
ONE OFDM SYMBOL
TIME
INPUT BIT SEQUENCE
CODING, MODULATION, ASSIGNMENT, SELECTION PROCESSING
PEAK POWER SUPPRESSION PROCESSING
(CHANGE, IFFT, PEAK DETERMINATION)
TRANSMISSION PROCESSING
TRANSMISSION
   FIG. 21
31 PEAK SUPPRESSING SECTION
32 OFDM SYMBOL SELECTING SECTION
   FIG. 22 FIG. 24
41 RECEPTION PROCESSING SECTION
42 MCS SELECTING SECTION
   FIG. 23
MCS NUMBER
REQUIRED SIR
   FIG. 24
51 MARGIN CALCULATING SECTION
   FIG. 25
SUBCARRIER
RECEPTION SIR
SELECTED MCS
MARGIN
   FIG. 26
61 CODING SECTION
P/S SECTION

1. A radio transmission apparatus comprising:
a coding section that codes data;
a modulation section that generates a symbol from coded data and places the symbol in one of a plurality of signal points on an IQ plane;
an assignment section that assigns the generated symbol to one of a plurality of subcarriers constituting a multicarrier signal;
a changing section that changes a phase of each of the plurality of subcarriers within a range that does not cross a decision boundary between the signal point in which a symbol assigned to each of the plurality of subcarriers is placed and an adjacent signal point;
a generating section that generates a multicarrier signal from the plurality of subcarriers with changed phases; and
a transmission section that transmits the multicarrier signal to a radio reception apparatus.

2. The radio transmission apparatus according to claim 1, wherein the changing section further changes an amplitude of each of the plurality of subcarriers within the range that does not cross the decision boundary between the signal point in which the symbol assigned to each of the plurality of subcarriers is placed and the adjacent signal point.

3. The radio transmission apparatus according to claim 2, wherein the changing section decreases an amplitude of each of the plurality of subcarriers to decrease transmission power.

4. The radio transmission apparatus according to claim 1, further comprising a determination section that measures peak power of the multicarrier signal and determine whether or not the peak power is equal to or greater than a threshold,
wherein the changing section increases a change amount when the peak power is equal to or greater than the threshold.

5. The radio transmission apparatus according to claim 1, wherein:
the modulation section performs adaptive modulation per subcarrier; and
the changing section decreases a change amount as an M-ary modulation level used in the modulation section is greater.

6. The radio transmission apparatus according to claim 1, wherein:
the modulation section performs adaptive modulation per subcarrier; and
the changing section makes a subcarrier among the plurality of subcarriers subject to change, the subcarrier having a difference equal to or greater than a threshold, between reception quality at the radio reception apparatus and required quality for a modulation scheme used in the modulation section.

7. The radio transmission apparatus according to claim 6, wherein the changing section determines a change amount according to the difference between the reception quality and the required quality.

8. The radio transmission apparatus according to claim 1, wherein:
the coding section codes the data to generate a systematic bit and a parity bit;
the modulation section modulates the systematic bit and the parity bit generated in the coding section to generate a symbol; and
the changing section makes a subcarrier, to which a symbol comprised of only the parity bit is assigned, subject to change among the plurality of subcarriers.

9. A radio communication base station apparatus comprising the radio transmission apparatus according to claim 1.

10. A radio communication mobile station apparatus comprising the radio transmission apparatus according to claim 1.

11. A peak power suppression method in multicarrier communication, comprising changing a phase of each of a plurality of subcarriers constituting a multicarrier signal within a range that does not cross a decision boundary between a signal point on an IQ plane in which a symbol assigned to each of the plurality of subcarriers is placed, and an adjacent signal point, to suppress a peak power of the multicarrier signal.
